(19) United States
(12) Patent Application Publication
(10) Pub. No.: US 2026/0184274 A1
(43) Pub. Date: Jul. 2, 2026

(54) POWER CONSUMPTION PREDICTIVE ANALYSIS AND IMPROVEMENT SUGGESTION SYSTEM FOR BATTERY ELECTRIC VEHICLE USING LARGE LANGUAGE MODEL

(71) Applicant: TOYOTA JIDOSHA KABUSHIKI KAISHA, Toyota-shi (JP)

(72) Inventors: Jiawei YONG, Tokyo (JP); Akie WATANABE, Tokyo (JP); Yusuke YAMAURA, Tokyo (JP); Kimi SUGAWARA, Tokyo (JP)

(73) Assignee: TOYOTA JIDOSHA KABUSHIKI KAISHA, Toyota-shi (JP)

(21) Appl. No.: 19/405,811

(22) Filed: Dec. 2, 2025

(30) Foreign Application Priority Data
Dec. 26, 2024 (JP) 2024-230968

(51) Int. Cl. B60R 16/023; G06F 40/40; G07C 5/04

(52) U.S. Cl. CPC B60R 16/0236; G06F 40/40; G07C 5/04

(57) ABSTRACT

A power consumption predictive analysis and improvement suggestion system for a battery electric vehicle, using a large language model (LLM), includes an estimation unit that uses LLM to estimate power consumption of a battery that will be consumed when traveling within a predetermined period into the future or within a period until a next charge, based on various types of information including various types of information related to a driver and the battery electric vehicle, and past traveling history related to battery electric vehicles of a same model, and that also uses the LLM to estimate an improvement approach to bring the power consumption that is estimated closer to a minimum value, and a suggestion unit that suggests the improvement approach that is estimated.

### CROSS-REFERENCE TO RELATED APPLICATION

This application claims priority to Japanese Patent Application No. 2024-230968 filed on December 26, 2024. The disclosure of the above-identified application, including the specification, drawings, and claims, is incorporated by reference herein in its entirety.

### BACKGROUND

### 1. Technical Field

The present disclosure is applicable to, for example, battery electric vehicles (so-called BEVs) and so forth that use batteries, and relates to the technical field of a system that performs predictive analysis of power consumption of a battery over a period of use of a battery electric vehicle into the relatively near future, such as for example, until use of the battery electric vehicle is completely ended today, over the next few days, the next week, until the end of the week, until the next charge, or the like, and suggests improvements regarding the power consumption.

### 2. Description of Related Art

As technology related to this type of system, a cruising range notification device has been developed for an automotive navigation system for a battery electric vehicle, in which the device displays a remaining cruising range indicating how far the vehicle can travel based on remaining charge of an in-vehicle battery, and performs notification regarding whether the vehicle can return to home or to a predetermined charging facility (see WO14/188652).

### SUMMARY

However, according to the background art described above, simply displaying information regarding the remaining cruising range and whether the destination can be reached, in an automotive navigation system, poses a technical problem in that it is difficult to suggest information regarding when and where charging should be performed, for example, before the end of the day when there are multiple destinations, or for the next few days, or further until the end of the week, and moreover to suggest approaches and actions to circumvent depleting remaining charge of the battery.

An object of the present disclosure is to provide a power consumption predictive analysis and improvement suggestion system for a battery electric vehicle, using an LLM, which can predict power consumption with prediction precision that is more correct, not simply for current traveling but for a specified period in the near future, and suggest improvement approaches regarding power consumption.

In order to solve the above problems, according to an aspect of the present disclosure, a power consumption predictive analysis and improvement suggestion system for a battery electric vehicle, using a large language model (LLM), includes an estimation unit that estimates, using the LLM, power consumption of a battery that will be consumed by the battery electric vehicle equipped with the battery traveling within a predetermined period from the present to the future or within a period until the battery electric vehicle is charged next time, based on various information related to a driver, the battery electric vehicle, and traveling, including (Ia) a current situation and traveling state, and (Ib) past traveling history, related to (I) the driver of the battery electric vehicle and to the battery electric vehicle, and (II) past traveling history related to battery electric vehicles of a same model as the battery electric vehicle, and also estimates, using the LLM, an improvement approach to bring the consumption power that is estimated closer to a minimum value, and a suggestion unit that suggests the improvement approach that is estimated to the driver.

According to one aspect of the system of the present disclosure, high-dimensional learning including text can be used to predict power consumption for a predetermined period in the near future (rather than simply for the current travelling) with prediction precision that is more correct, in accordance with various types of states and situations of a user and the battery electric vehicle on a daily basis, and improvement approaches to power consumption can be suggested.

Such advantageous effects of the present disclosure will become more apparent from the embodiments of the disclosure described below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an overall configuration of a system according to an embodiment; and

FIG. 2 is a flowchart showing an example of processing in the system according to the embodiment.

### DETAILED DESCRIPTION OF EMBODIMENTS

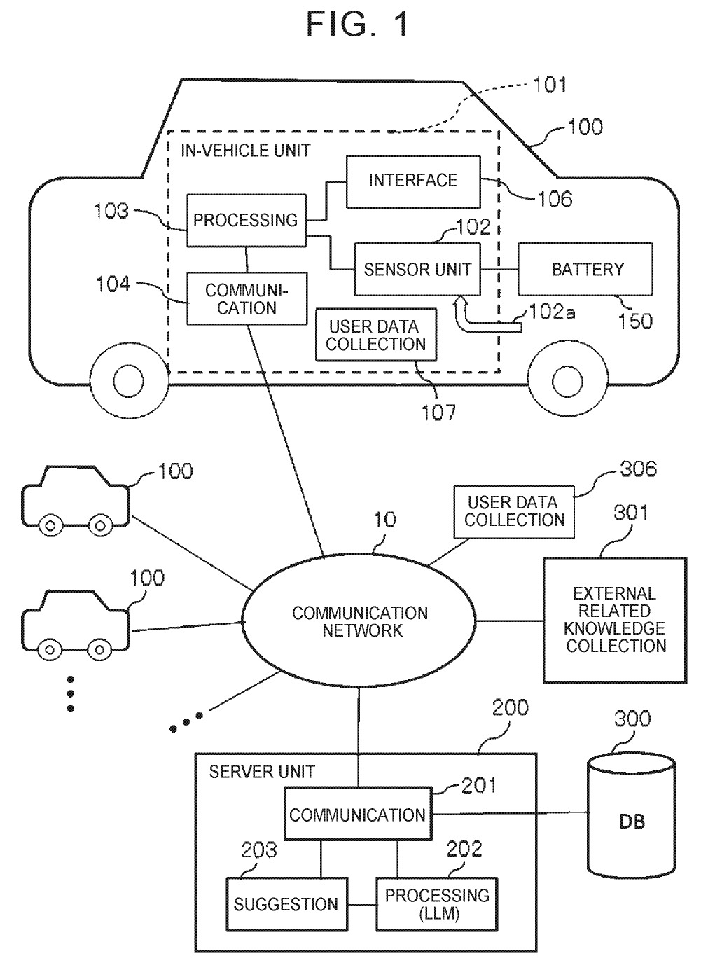

First, an overall configuration of a power consumption predictive analysis and improvement suggestion system for a battery electric vehicle using a large language model (LLM) according to an embodiment (hereinafter simply referred to as "analysis and improvement suggestion system" as appropriate) will be described with reference to FIG. 1.

The LLM used for analysis and estimation according to the present embodiment, or used for suggestions through linguistics, may be a so-called single-modal LLM or may be a multi-modal LLM. In the present embodiment, various types of information related to a driver, the battery electric vehicle, and traveling, including the current situation, traveling state, and past traveling history, relating to the driver of the battery electric vehicle and the battery electric vehicle, is used as source data for LLM learning. Furthermore, the present embodiment uses, as source data for LLM learning, various types of information related to the driver, the battery electric vehicle, and traveling, including past traveling history of battery electric vehicles of the same model as the battery electric vehicle. The system according to the present embodiment is constructed as a system that performs LLM analysis or artificial intelligence (AI) analysis based on these various types of information.

Specifically, the system is constructed to estimate power consumption with high precision for a specified period in the near future, based on the various types of states, situations, and so forth, of the user or driver and of the battery electric vehicle on a daily basis, and to suggest improvement approaches to improve power consumption in a way that will easily convince the user or driver, which will be described in detail below.

Note that such AI learning or LLM learning can employ traditional AI learning systems, such as so-called supervised learning, unsupervised learning, or reinforcement learning, as well as new technologies such as generative AI, LLMs, and so forth, that have recently been put into practical use, that are currently under development, or that will be developed in the future. For example, AI learning or LLM learning here may be configured using a neural network that performs efficient learning through representation learning, transfer learning, feature selection, fine tuning or hyperparameter tuning, ensemble learning, or the like.

As illustrated in FIG. 1, the analysis and improvement suggestion system according to the embodiment is configured including an in-vehicle unit 101 installed in a battery electric vehicle 100, and a server unit 200. The in-vehicle unit 101 and the server unit 200 are accommodated in a communication network 10 such as the Internet, a dedicated network, or the like. The communication network 10 also accommodates a plurality of or a great number of other battery electric vehicles 100 in the same way. The communication network 10 also accommodates an external related knowledge collection unit 301 that collects information obtained outside the battery electric vehicle 100 and that can be subjected to execution of fine tuning or hyper tuning in the analysis and improvement suggestion system and used to provide domain knowledge (i.e., "external related knowledge"). Further, the communication network 10 also accommodates a user data collection unit 306 that collects data unique to the driver or the user of the battery electric vehicle 100 (i.e., "user data"). The external related knowledge collection unit 301 and the user data collection unit 306 may be provided at least in part within the server unit 200 or within a facility in which the server unit 200 is located, or may be provided within the in-vehicle unit 101 or within the vehicle.

The server unit 200 is connected to a database 300 in which various types of data, including data used in the analysis and improvement suggestion system, are stored. The database 300 may be connected to the server unit 200 or the in-vehicle unit 101 via the communication network 10. The server unit 200 is made up including various types of computer-installed devices and various types of computer devices that perform centralized processing or distributed processing, and in other words, the analysis and improvement suggestion system is constructed as a system that performs centralized processing or distributed processing using the large-scale data in the database 300.

In FIG. 1, the battery electric vehicle 100 includes a battery 150 and is configured as, for example, a BEV. The battery electric vehicle 100 may also be a so-called hybrid electric vehicle (HEV), a plug-in HEV (PHEV), a fuel cell EV (FCEV), or the like, which uses a battery.

The in-vehicle unit 101 is configured including a sensor unit 102 that includes various types of sensors laid out at predetermined positions within the vehicle, a processing unit 103 that includes a computer, a communication unit 104 that includes a modem or the like configured to be capable of external communication from the vehicle via the communication network 10, an interface unit 106 that is configured to be capable of interchange with the user or the driver inside the vehicle by speech and images, and a user data collection unit 107.

As one of the detection functions thereof, the sensor unit 102 detects remaining charge data of the battery 150 and passes the data to the processing unit 103. The sensor unit 102 is also configured to detect various types of information 102a related to the current traveling state of the battery electric vehicle 100 and the driver of the battery electric vehicle 100, and pass this information to the processing unit 103 as controller area network (CAN) data or the like.

The processing unit 103 has a CPU that controls the sensor unit 102, the communication unit 104, and the interface unit 106, memory, and so forth, and transmits various types of information related to the driver and traveling of the battery electric vehicle 100, including a planned route of the battery electric vehicle 100, the current traveling state and past traveling history of the battery electric vehicle 100, from the communication unit 104 to the server unit 200 side, as data in a predetermined format. Further, the interface unit 106 is configured to suggest to the user or the driver, via the communication unit 104, improvement approaches and so forth, indicated by improvement approach data and so forth that is received from the server unit 200 side after processing thereat.

Under the control of the processing unit 103, the communication unit 104 transmits data, collected by the battery electric vehicle 100, that is necessary for power consumption predictive analysis and improvement suggestions, to the server unit 200 via the communication network 10. Further, the server unit 200 is configured to receive, via the communication network 10, the results of the power consumption predictive analysis of the battery electric vehicle 100 generated using the LLM, and data related to improvement suggestions.

The interface unit 106 is configured to enable input of the destination of the battery electric vehicle 100, conditions for selecting a planned route to the destination, and so forth, by speech input or predetermined operations on an image, or the like. The selection of the planned route here (i.e., navigation function) may be configured such that all or part thereof is executed by the processing unit 103, or such that part or a main part thereof is executed by a processing unit 202 on the server unit 200 side (in other words, the in-vehicle unit 101 side mainly serves as a browser function). The interface unit 106 is further configured to be able to output the results of the power consumption predictive analysis and data relating to improvement suggestions obtained from the server unit 200 side in a predetermined format, either as speech output or on an image.

The user data collection unit 107 is configured to collect data unique to the driver or the user of the battery electric vehicle 100 (i.e., "user data") within the battery electric vehicle 100, separately from the sensor unit 102. The user data is attribute data unique to the user, such as for example, gender, age, driving experience, accident history, preferences, driving habits, fatigue level, medical history, chronic illnesses, and so forth.

The user data collection unit 306 collects user data via a personal computer (PC), a smartphone, a dedicated app, or the like, which are omitted from illustration, owned by or associated with the user or the driver, and may or may not be accommodated in the communication network 10. The user data collection unit 306 passes the collected user data to the server unit 200 via the communication network 10, so as to contribute to LLM learning thereat. Thus, the user data collection unit 306 externally collects user data from outside of the battery electric vehicle 100, and the aforementioned user data collection unit 107 internally collects user data inside the battery electric vehicle 100, whereby user data can be extensively collected. The user data is used in processing relating to the LLM in the processing unit 202, in a form in which at least a part of the data is converted into text or is verbalized.

In FIG. 1, the server unit 200 is configured including a communication unit 201 that includes a modem or the like that is capable of communicating with each of the battery electric vehicles 100, and also with the external related knowledge collection unit 301 and the user data collection unit 306 via the communication network 10, the processing unit 202 including a computer that is capable of executing processing such as LLM-based power consumption estimation processing or the like, which will be described in detail later, and a suggestion unit 203 that is capable of generating suggestion data that suggests improvement approaches in accordance with the estimation results from the processing unit 202.

The communication unit 201 receives, under the control of the processing unit 202, data collected by the battery electric vehicle 100, that is necessary for power consumption predictive analysis and improvement suggestions, via the communication network 10. Under the control of the processing unit 202, the communication unit 201 receives the external related knowledge collected by the external related knowledge collection unit 301 and the user data collected by the user data collection unit 306 via the communication network 10, as part of the data that is necessary for power consumption predictive analysis and improvement suggestions. The communication unit 201 is further configured to transmit the results of the power consumption predictive analysis and data related to improvement suggestions, which have been processed and generated by the processing unit 202 and the suggestion unit 203, via the communication network 10, to the battery electric vehicle 100 side, which is the subject of this analysis.

The processing unit 202 is configured to estimate, using the LLM, the power consumption of the battery 150 that will be consumed when the battery electric vehicle 100 that is the subject of the current analysis travels within a predetermined period from the present to the future (e.g., three days, five days, one week, ten days, one month, etc.) or within a period until the battery electric vehicle 100 is charged next time, based on information related to the driver of the battery electric vehicle 100, the battery electric vehicle 100, and the traveling, including (Ia) a current situation and traveling state, and (Ib) past traveling history, related to (I) the driver of the battery electric vehicle 100 and to the battery electric vehicle 100, and (II) past traveling history related to battery electric vehicles 100 of a same model as the battery electric vehicle 100, and to estimate, using the LLM, improvement approaches for bringing the power consumption estimated here closer to the minimum value.

The suggestion unit 203 is configured to generate suggestion data for suggesting the improvement approaches estimated in this way to the driver or the user of the battery electric vehicle 100, in a predetermined format corresponding to the interface unit 106 provided inside the battery electric vehicle 100, and to pass the data to the communication unit 201. In the present embodiment, the "suggestion unit" is thus configured to include the suggestion unit 203 on the server unit 200 side and the interface unit 106 on the in-vehicle unit 101 side, and the in-vehicle unit 101 side is mainly responsible for the browser function with regard to the suggestion function.

The database 300 is configured to include a large-scale, high-speed data input/output storage device that stores various types of data received by the server unit 200 side via the communication network 10, in particular various types of data required for estimation processing using the LLM, data related to the estimation results or intermediate progress generated by the processing unit 202, suggestion data generated by the suggestion unit 203, and so forth.

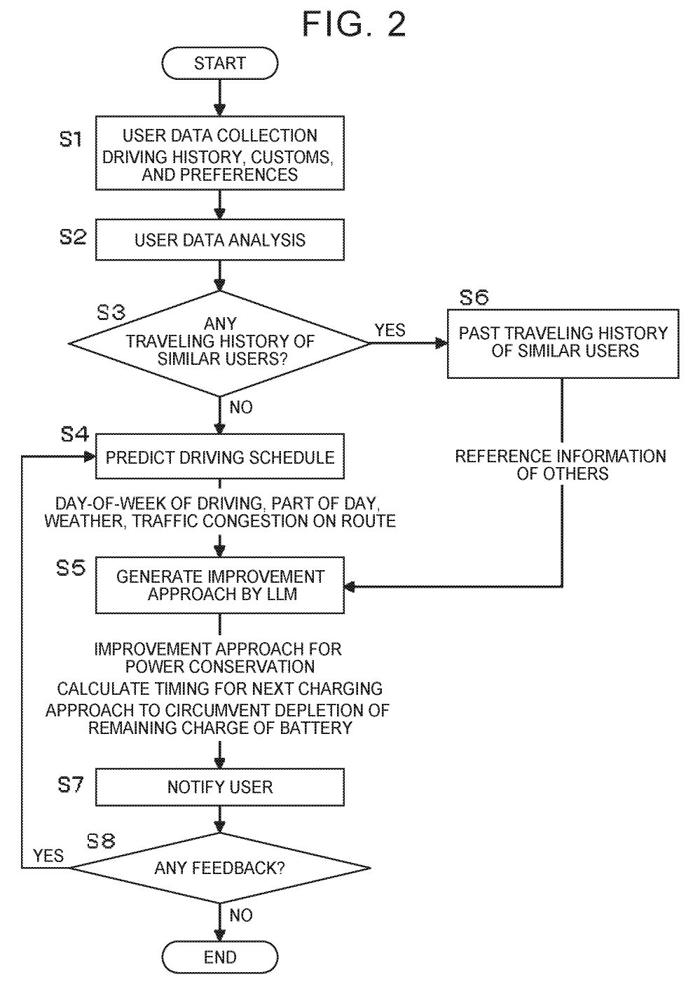

Next, referring to the flowchart in FIG. 2 in addition to the block diagram in FIG. 1, an example of processing in the analysis and improvement suggestion system according to the present embodiment (in particular, processing executed using the LLM in the processing unit 202 in the server unit 200) will be described.

In FIG. 2, first, user data such as driving history, customs, preferences, and so forth, relating to the driver or the user who drives the battery electric vehicle 100, is collected by the user data collection unit 107 and the user data collection unit 306 (step S1).

Subsequently, the user data that is collected is passed to the processing unit 202 on the server unit 200 side, via the communication network 10. The processing unit 202 analyzes the user data (step S2) and determines whether there is a traveling history of a similar user (step S3). The analysis here may include classification processing into appropriate categories, processing of converting into text, or verbalization processing. Here, "similar users" typically refer to users who have traveled the same route in a "battery electric vehicle BEV of the same model". Furthermore, a "BEV of the same model" can include not only a BEV of exactly the same model or same type as the BEV owned by the driver or the user, but also a BEV having common specifications or similar specifications that are set in advance. For example, when the powertrains of both vehicles are the same or navigation numbers are the same, they can be treated as being the same model here. Furthermore, slight differences between both vehicles may be corrected by the LLM such that they can be treated as vehicles of the same model or vehicles of the same type of user. As described above, the determination in step S3 as to whether the user is a similar user is based on predetermined references, based on the similarity of the battery electric vehicle 100 being driven and the similarity of the travel route.

When the determination result indicates that there is no traveling history of a similar user (No in step S3), the processing unit 202 then executes prediction of the driving schedule of the battery electric vehicle 100 (step S4). More specifically, predictions of the day-of-week of driving (i.e., the day-of-week when the vehicle will likely be driven on the next or an upcoming day), part of day (i.e., part of the day when the vehicle will likely be driven), weather (i.e., weather on that day or part of day at the location where the vehicle will likely be driven), and congestion on the route (i.e., congestion on the route and at the part of day when the vehicle will likely be driven), or the like, are executed by the processing unit 202 through estimation using AI or LLM. Further, the processing unit 202 generates power consumption improvement approaches for the traveling schedule that is predicted in this way, by the LLM (step S5).

On the other hand, when the determination results indicate that there is a traveling history of a similar user (Yes in step S3), the past traveling history of the similar user is obtained from the database 300, the user data collection unit 107 in another battery electric vehicle 100, or the external related knowledge collection unit 301 (step S6). Next, the processing unit 202 generates power consumption improvement approaches in the travelling schedule described above by the LLM, by employing the original data for the LLM as reference information of others (step S5).

The external related knowledge collection unit 301 may acquire external related knowledge prior to the processing using the LLM in step S5, such as for example, in parallel with, before, or after step S1. Thus, the processing unit 202 may execute fine tuning or hyper tuning in step S5 or the like, as processing to impart domain knowledge. Using an LLM that has been fine-tuned with domain knowledge related to battery electric vehicles, such as BEV domain knowledge or the like, enables improvement approaches to be generated by comparing with optimal traveling settings.

In estimating an "improvement approach" using the LLM in step S5, the processing unit 202 may extract the equivalent of "minimum power consumption" from the past traveling history acquired in step S6, and the improvement approach may be estimated based on this past traveling history, for example. In this case, the difference between the traveling method (part of day of traveling, traveling route, way of traveling, and so forth) corresponding to the minimum power consumption, which is extracted, and the current traveling method, may be identified using the LLM, and an approach to reduce this difference may be estimated as an improvement approach. For these reasons, using the LLM to convert into text and then perform vectorization processing all of the relationship graphs and numerical data between elements and power consumption, accumulated for each road link, can improve the overall processing efficiency and precision.

In this way, according to the present embodiment, the LLM that is run in step S5 and the like uses, as the great amount of text data, various types of information related to the driver, the battery electric vehicle 100, and the traveling thereof, including the current situation, traveling state, and past traveling history related to the driver of the battery electric vehicle 100 and to the battery electric vehicle 100, for example. Further, the present embodiment uses various types of information related to the driver, the battery electric vehicle 100 and traveling, including the past traveling history relating to battery electric vehicles of the same model as the battery electric vehicle 100. The various types of information include, as appropriate, personal information, information regarding traffic laws and common knowledge related to traffic laws (e.g., which side of the road to drive on, speed limits in residential areas, and so forth), and information relating to general common knowledge (e.g., it is dark at night, traffic jams are likely to occur during rush hours and during consecutive holidays, the presence of landmarks near the planned route, and so forth), and a large amount of such information that is converted into text or verbalized is used.

Note, however, that a multimodal LLM that is capable of AI learning based not only on verbalized information but also on non-verbalized information may be adopted in these steps S5 and so forth. That is to say, the data used in the processing of step S5 and so forth includes text data, but is not limited to text data.

In the processing of step S5 and so forth described above, a large amount of text data is used in this way to perform fine tuning and so forth of the LLM. As a result, application can be made to various types of natural language processing (NLP) tasks such as text classification, sentiment analysis, information extraction, text summarization, text generation, question answering, and so forth.

Regardless of whether going through step S4 or through step S6, improvement approaches, such as improvement approaches for power conservation, calculation of the next charging timing, and improvement approaches to circumvent depleting remaining charge of the battery, for example, are generated using the LLM based on the large amount of text data and so forth that is available, as described above (step S5).

In step S7, the suggestion unit 203 further generates suggestion data to suggest the improvement approaches generated by the LLM in this way, and the "improvement approaches" are output as speech or as images by the interface unit 106 on the in-vehicle unit 101 side, as notification to the user of the battery electric vehicle 100. In addition, the processing unit 202 and the suggestion unit 203 also output suggestion data for suggesting "grounds" for the improvement approaches as speech or as images on the interface unit 106. Note that it is also preferable to use the LLM to execute generating of suggestion data for outputting the improvement approaches and so forth as speech or as images by the suggestion unit 203. That is to say, suggestions by AI speech and AI images may be made to the user or the driver in accordance with various types of natural language processing tasks such as text classification, sentiment analysis, information extraction, text summarization, text generation, and question answering, here as well.

Next, determination is made regarding whether there is feedback (step S8), and when there is (YES in step S8), the processing returns to step S4 and the subsequent steps are repeatedly executed, and "improvement approaches" updated through AI learning are suggested (step S7).

The "improvement approaches" notified or suggested here is preferably notified or suggested along with the "grounds" thereof, from the perspective of convincing the user or the driver, in other words, from the perspective of causing the driver to follow the improvement approaches.

For example, a suggestion is made that the user is to "perform charging one time at night sometime over the next week". This allows charging to be performed during a part of day when electricity rates are low, thereby conserving costs and ensuring that the remaining charge in the battery 150 is sufficient. The effect of this is that charging costs can be reduced by charging at a time when electricity rates are low. Also, the remaining charge of the battery 150 necessary for traveling over the next week can be secured, and a situation in which power is depleted can be circumvented. In this case, along with suggesting the improvement approach, suggestion or notification is made to the user regarding the grounds for suggesting the improvement approach, such as for example, "Based on your traveling history over the past week and your future plans, it is predicted that battery consumption will exceed the current remaining charge. By charging at night, you can reduce costs and replenish power".

For example, a suggestion is made that the user is to "refrain from frequent acceleration and deceleration during rush hours, and drive at a steady speed". The effect is that by improving driving customs, power consumption can be reduced by about 15%, extending the cruising range of the vehicle and reducing the number of times that charging is necessary. In this case, along with suggesting the improvement approach, suggestion or notification is made to the user regarding the grounds for suggesting the improvement approach, such as for example, "Analysis of driving data during rush hour in the past has revealed that frequent acceleration and deceleration is the cause of increased power consumption. Changing your driving method during future rush hours can effectively reduce energy consumption".

Also, for example, a suggestion is made that the user is to "warm the car in advance and moderately reduce air conditioning use, in preparation for the drop in temperatures over the next few days". The effect is that unnecessary power consumption by the air conditioning and heating systems will be reduced, and improved cruising range of the battery 150 can be anticipated. In this case, along with suggesting the improvement approach, suggestion or notification is made to the user regarding the grounds for suggesting the improvement approach, such as for example, "Based on the weather forecast and past data on power consumption at low temperatures, it has been predicted that unless the use of the air conditioner is adjusted, power consumption will increase significantly and there is a possibility that the cruising range will be insufficient".

When determination is made in step S8 that there is no feedback (No in step S8) after the processing of suggesting such improvement approaches, the series of processing ends.

As described in detail above, according to the present embodiment, improvement approaches to conserve power, or approaches and handling regarding the timing for when to perform charging next or to circumvent depleting remaining charge of the battery before charging (step S5), are suggested to the user linguistically or by speech in advance or in real time (step S7), based not simply on traveling to the destination this time, but also on the traveling history of the battery electric vehicle 100 by this user, the cyclicity and features of the traveling, or traveling history of other battery electric vehicles 100 that are traveling ahead on the same route or that have traveled thereon in the past, the traveling history of other battery electric vehicles 100 that are traveling on or that have traveled on the same route or nearby routes, and so forth (step S6), and further based on everyday driving habits, customs, tendencies, preferences, and so forth, of the user (step S1), and further on the driving schedule of the user, and so forth (step S4), including the day-of-week, part of day, the weather at that time, traffic congestion on the route, and so forth, when the user is expected to travel in the vehicle in the near future.

Additionally, according to the present embodiment, in response to user feedback (step S8), improvement approaches that take personal preferences into greater consideration can be suggested from the next time onwards (steps S4 to S7). Thus, LLM-specific feedback mechanisms such as reinforcement learning from human feedback (RLHF) or the like can be utilized to reflect personal preferences. This enables collecting feedback on each factor that affects power consumption and generating new improvement approaches that are more tailored to the individual.

Thus, according to the present embodiment, using LLM enables not only extracting numerical data such as in the conventional technology or background art or the like, but also extracting relevant features from text data such as papers and related literature, and accordingly power consumption can be calculated or estimated at a higher dimension. Further, according to the present embodiment, using LLM enables results, grounds, and improvement approaches to be simultaneously provided to the user in natural language or speech, thereby increasing the convincement and satisfaction of the user with the reply.

### Appendices

The following appendices are further disclosed regarding the above-described embodiment.

### Appendix 1

In a battery electric vehicle equipped with a battery, an analysis and improvement suggestion system according to Appendix 1 of the present disclosure includes an estimation unit that estimates, using an LLM, power consumption of a battery that will be consumed by driving the battery electric vehicle equipped with the battery within a predetermined period from the present to the future or within a period until the battery electric vehicle is charged next time, based on various information related to a driver, the battery electric vehicle, and the traveling, including (Ia) a current situation and traveling state, and (Ib) past traveling history, related to (I) the driver of the battery electric vehicle and to the battery electric vehicle, and (II) past traveling history related to battery electric vehicles of a same model as the battery electric vehicle, and also estimates, using the LLM, an improvement approach to bring the consumption power that is estimated closer to a minimum value, and a suggestion unit that suggests the improvement approach that is estimated to the driver.

According to the analysis and improvement suggestion system in Appendix 1, using the LLM enables high-dimensional learning including text or also including text to be used to predict power consumption for a predetermined period in the near future with prediction precision that is more correct, in accordance with various types of states and situations of the user and the battery electric vehicle on a daily basis, and factors that have the greatest impact on power consumption, and improvement approaches, can also be described in natural language that humans can understand. This also enables the traveling history that is collected to be provided as useful information for other vehicles. Suggesting such improvement approaches also leads to teaching users how to drive their battery electric vehicles in a way that will conserve power as they use them on a daily basis.

### Appendix 2

The analysis and improvement suggestion system of Appendix 2 of the present disclosure is the power consumption predictive analysis and improvement suggestion system according to Appendix 1, in which the estimation unit estimates the improvement approach by identifying a difference between a current traveling state and a traveling state with minimum power consumption in the past traveling history, using the LLM.

According to the analysis and improvement suggestion system in Appendix 2 of the present disclosure, using the LLM to identify difference between the current traveling state and the traveling state with minimum power consumption in the past traveling history enables relatively efficient estimation of improvement approaches to bring power consumption closer to the minimum value.

### Appendix 3

The analysis and improvement suggestion system of Appendix 3 of the present disclosure is the power consumption predictive analysis and improvement suggestion system according to Appendices 1 or 2, in which the estimation unit acquires external related knowledge other than information related to the current traveling state and the past traveling history, and estimates the improvement approach taking into consideration domain knowledge related to the battery electric vehicle using an LLM that is fine-tuned using the external related knowledge that is acquired.

According to the analysis and improvement suggestion system in Appendix 3 of the present disclosure, improvement approaches are estimated not only based on information related to the current traveling state and the past traveling history, but also taking domain knowledge into consideration with an LLM that is fine-tuned using external related knowledge, thereby enabling estimation with higher precision.

### Appendix 4

The analysis and improvement suggestion system of Appendix 4 of the present disclosure is the power consumption predictive analysis and improvement suggestion system according to any one of Appendices 1 to 3, in which the estimation unit acquires information related to personal preferences of the driver of the battery electric vehicle, and estimates the improvement approach using the LLM in a way that reflects personal preferences by utilizing an LLM-dedicated mechanism for feedback of the information related to the personal preferences that is acquired.

According to the analysis and improvement suggestion system in Appendix 4 of the present disclosure, improvement approaches are estimated by the LLM not only based on information relating to the current traveling state and the past traveling history but also in a form that reflects personal preferences, and accordingly suggesting of highly precise improvement approaches that are suitable for the driver or the user can be performed in a more convincing manner.

### Appendix 5

The analysis and improvement suggestion system of Appendix 5 of the present disclosure is the power consumption predictive analysis and improvement suggestion system according to any one of Appendices 1 to 4, in which the suggestion unit suggests, along with the improvement approach, information indicating grounds for estimating the improvement approach.

According to the analysis and improvement suggestion system in Appendix 5 of the present disclosure, not only improvement approaches but also the grounds for the improvement approaches are suggested, thereby enabling highly precise improvement approaches to be suggested in a form that is easier for the driver or the user to understand.

### Appendix 6

In a battery electric vehicle equipped with a battery, an analysis and improvement suggestion system according to Appendix 6 of the present disclosure includes estimating, using an LLM, power consumption of a battery that will be consumed by driving on a planned route when traveling to a destination, based on information relating to a driver of the battery electric vehicle and to traveling, including a current traveling state and past traveling history of the battery electric vehicle, and past traveling history related to battery electric vehicles of a same model as the battery electric vehicle, and also estimating, using the LLM, an improvement approach to bring the power consumption that is estimated closer to a minimum value, and suggesting the improvement approach that is estimated to the driver.

According to the analysis and improvement suggestion method in Appendix 6 of the present disclosure, similar to the analysis and improvement suggestion system described in Appendix 1, using the LLM enables high-dimensional learning including text or also including text to be used to predict power consumption with prediction precision that is more correct, and factors that have the greatest impact on power consumption, and improvement approaches, can also be described in natural language that humans can understand.

The present disclosure can be modified as appropriate within a scope that does not contradict the gist or idea of the disclosure that can be read from the claims and the entire specification, and the analysis and improvement suggestion system and method, involving such modifications, are also included in the technical idea of the present disclosure.

What is claimed is:

1. A power consumption predictive analysis and improvement suggestion system for a battery electric vehicle, using a large language model (LLM), the power consumption predictive analysis and improvement suggestion system comprising:
an estimation unit that estimates, using the LLM, power consumption of a battery that will be consumed by driving the battery electric vehicle equipped with the battery within a predetermined period from the present to the future or within a period until the battery electric vehicle is charged next time, based on various information related to a driver, the battery electric vehicle, and traveling, including (Ia) a current situation and traveling state, and (Ib) past traveling history, related to (I) the driver of the battery electric vehicle and to the battery electric vehicle, and (II) past traveling history related to battery electric vehicles of a same model as the battery electric vehicle, and also estimates, using the LLM, an improvement approach to bring the consumption power that is estimated closer to a minimum value; and
a suggestion unit that suggests the improvement approach that is estimated to the driver.

2. The power consumption predictive analysis and improvement suggestion system according to claim 1, wherein the estimation unit estimates the improvement approach by identifying a difference between a current traveling state and a traveling state with minimum power consumption in the past traveling history, using the LLM.

3. The power consumption predictive analysis and improvement suggestion system according to claim 1, wherein the estimation unit acquires external related knowledge other than information related to the current traveling state and the past traveling history, and estimates the improvement approach taking into consideration domain knowledge related to the battery electric vehicle using an LLM that is fine-tuned using the external related knowledge that is acquired.

4. The power consumption predictive analysis and improvement suggestion system according to claim 1, wherein the estimation unit acquires information related to personal preferences of the driver of the battery electric vehicle, and estimates the improvement approach using the LLM in a way that reflects personal preferences by utilizing an LLM-dedicated mechanism for feedback of the information related to the personal preferences that is acquired.

5. The power consumption predictive analysis and improvement suggestion system according to claim 1, wherein the suggestion unit suggests, along with the improvement approach, information indicating grounds for estimating the improvement approach.

6. A power consumption predictive analysis and improvement suggestion method for a battery electric vehicle, using a large language model (LLM), the power consumption predictive analysis and improvement suggestion method comprising:
estimating, using the LLM, power consumption of a battery that will be consumed by the battery electric vehicle equipped with the battery traveling within a predetermined period from the present to the future or within a period until the battery electric vehicle is charged next time, based on various information related to a driver, the battery electric vehicle, and the traveling, including (Ia) a current situation and traveling state, and (Ib) past traveling history, related to (I) the driver of the battery electric vehicle and to the battery electric vehicle, and (II) past traveling history related to battery electric vehicles of a same model as the battery electric vehicle, and also estimating, using the LLM, an improvement approach to bring the power consumption that is estimated closer to a minimum value; and
suggesting the improvement approach that is estimated to the driver.
